(19) United States
(12) Patent Application Publication
(10) Pub. No.: US 2018/0129743 A1
(43) Pub. Date: May 10, 2018

(54) METHOD FOR DISPLAYING INFORMATION COMPLEMENTARY TO A SEARCH ENTRY CARRIED OUT IN A FIRST DATABASE

(71) Applicant: QWANT, Paris (FR)

(72) Inventor: Eric LEANDRI, Paris (FR)

(21) Appl. No.: 15/567,375

(22) PCT Filed: Apr. 20, 2016
(86) PCT No.: PCT/FR2016/050918

§ 371 Date: Oct. 18, 2017

(30) Foreign Application Priority Data
Apr. 20, 2015 (FR) 1553516

(51) Int. Cl. G06F 17/30

(52) U.S. Cl. CPC G06F 17/30864; G06F 17/30268; G06F 17/30663; G06F 17/30882

(57) ABSTRACT

The invention relates to a method (10) for displaying information complementary to a search entry carried out in a first database. Said invention comprises:
a first step (105) of displaying, on a screen of a connected terminal, an area for entering characters related to a search to be carried out in the first database,
a step (110) of entering at least one character in the input area of the search to be carried out,
a step (115) of detecting each character entered,
a step (120) of selecting, in a second database, at least one hyperlink as a function of each detected character and
a second step (125) of displaying each selected hyperlink in the input area.

### TECHNICAL FIELD OF THE INVENTION

The present invention relates to a method for displaying information complementary to a search entry carried out in a first database. It applies, in particular, to the optimization of energy and time related to the operation of a search engine.

### STATE OF THE ART

In the field of search engines, it is usual to return sponsored search results to a search request made by a user. These results, marked as such or not, appear in the list of displayed results.

The drawback of these systems is that they overload a user of the search engine with results whose relevance is not objective, ie selected based on the same search algorithm as the other, non-sponsored, results displayed.

This overloading induces a feeling of distrust in the user with regard to the results proposed, as well as limiting the number of non-sponsored results displayed, ie actually obtained from the search algorithm of the search engine.

This display limitation can compel the user to view several pages of results before finding the subject of the search, which leads to drawbacks of the network being overloaded and of additional energy being used, by the user's terminal or the network in particular.

### SUBJECT OF THE INVENTION

The present invention aims to remedy all or part of these drawbacks.

To this end, according to a first aspect, the present invention relates to a method for displaying information complementary to a search entry carried out in a first database, which comprises:
a first step of displaying, on a screen of a connected terminal, an area for entering characters related to a search to be carried out in the first database;
a step of entering at least one character in the input area of the search to be carried out;
a step of detecting each character entered;
a step of selecting, in a second database, at least one hyperlink as a function of each detected character; and
a second step of displaying each selected hyperlink in the input area.

Thanks to these provisions, the hyperlink is displayed in the input area and makes it possible to navigate to the hyperlink address without the search results having to be displayed. Secondly, the search results displayed are, for example, non-sponsored results, and therefore are more objective. In this way, the number of results to be displayed so that a user selects a non-sponsored search result is reduced.

In some embodiments, the input area comprises an area for displaying predictive search complements, with at least one selected hyperlink being displayed in the display area, each said hyperlink being selected as a function of a displayed predictive search complement.

These embodiments make it possible to select hyperlinks to be displayed as a function of complements obtained from a predictive search displayed.

In some embodiments, each character entered is displayed in a first portion of the input area, each hypertext link being displayed in a second portion of the input area, different from the first portion.

These embodiments make it possible to improve the ease of understanding of the page displayed by displaying a hyperlink directly in the input area.

In some embodiments, the hyperlink is in the form of an image.

These embodiments allow richer information to be displayed with regard to the space of the page occupied by the hyperlink.

In some embodiments, each hyperlink is also selected as a function of a user profile.

These embodiments allow a more relevant selection of each hyperlink to be displayed.

In some embodiments, each hyperlink is also selected as a function of an item of information representative of a cookie of a browser displaying the input area.

These embodiments allow a more relevant selection of each hyperlink to be displayed.

In some embodiments, the method that is the subject of the present invention comprises, after the detection step, a step of determining at least one keyword neighboring at least one keyword formed by each character entered, the selection step being performed as a function of at least one determined neighboring keyword.

These embodiments make it possible, in particular, to take an entry error made by the user into account.

In some embodiments, the display step displays in priority a hyperlink selected as a function of at least one character detected relative to a hyperlink selected as a function of at least one determined neighboring keyword.

These embodiments make it possible to display in priority a hyperlink from a set of characters intentionally formed by the user.

In some embodiments, the display step displays a plurality of hyperlinks in succession.

These embodiments allow scrolling displayed hyperlinks.

In some embodiments, each hyperlink of the plurality of hyperlinks is displayed according to an order determined as a function of a keyword number determined as a function of each character entered that led to said keyword being selected.

These embodiments make it possible to display in priority a hyperlink that is relevant with regard to characters entered in the input area.

### BRIEF DESCRIPTION OF THE FIGURES

Other advantages, aims and particular features of the invention will become apparent from the non-limiting description that follows of at least one particular embodiment of the method that is the subject of the present invention, with reference to drawings included in an appendix, wherein:

FIG. 1 represents, schematically, a logical diagram of particular steps of the method that is the subject of the present invention;

FIG. 2 represents, schematically, a particular embodiment of a display realized after an iteration of the method that is the subject of the present invention; and

FIG. 3 represents, schematically, a particular embodiment of a device utilizing the method that is the subject of the present invention.

### DESCRIPTION OF EXAMPLES OF REALIZATION OF THE INVENTION

The present description is given as a non-limiting example, each characteristic of an embodiment being able to be combined with any other characteristic of any other embodiment in an advantageous way. In addition, each parameter of an example of realization can be utilized independently from the other parameters of said example of realization.

“Connected terminal” means a device comprising at least a screen and a means of communication with a data network. This data network is, for example, a mobile data network, or an internet- or intranet-type network. The communication means utilizes, for example, wired technology, such as an Ethernet cable, or wireless technology, such as the protocols of the IEEE 802.11 standard, known as “Wi-Fi”, or a 3G or 4G type of mobile network. Such a connected terminal is, for example:
a computer;
a smartphone; or
a digital tablet.

It is now noted that the figures are not to scale.

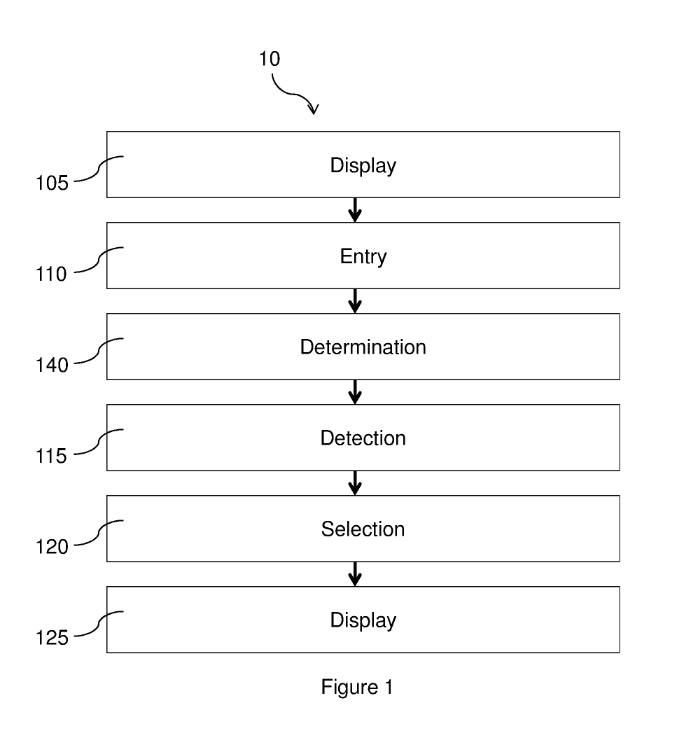

FIG. 1, which is not to scale, shows a cross-section view of an embodiment of the method 10 that is the subject of the present invention. This method 10 for displaying information complementary to a search entry carried out in a first database comprises:
a first step 105 of displaying, on a screen of a connected terminal, an area for entering characters related to a search to be carried out in the first database;
a step 110 of entering at least one character in the input area of the search to be carried out;
a step 115 of detecting each character entered;
a step 120 of selecting, in a second database, at least one hyperlink as a function of each detected character; and
a second step 125 of displaying each selected hyperlink in the input area.

When a user wants to carry out a search on the connected terminal, a search interface is initially displayed. This interface comprises an area for entering characters, the characters entered by the users enabling the search to be carried out.

This input area is displayed during the first display step 105. This first display step utilizes, for example, an electronic circuit controlling the screen, such as a motherboard or a graphics processor. This input area is displayed, for example, in a page of a browser.

During the entry step 110, by means of a man-machine interface such as a keyboard or a virtual mouse and keyboard, for example, the user enters at least one character in the input area 110. Preferably, each character entered in this way is displayed in the input area 110. The search in the first database is carried out as a function of at least one character entered by the user.

The step 115 of selecting each character entered is performed, for example, by a computer server detecting each character entered in real time. This computer server is connected to the connected terminal via the communication means.

This computer server is connected to two databases. In the first database, addresses of sites for the purpose of the search desired by the user are stored. The search utilizes a first algorithm for sorting site pages based on the popularity of the site pages, for example. In the second database, addresses of sponsored sites are stored, a second sort algorithm making it possible to select at least one relevant sponsored site page.

Irrespective of the fact that the search is carried out, ie that the user confirms the character entry performed or that this search is carried out in real time as a function of characters entered at a given time, at least one hyperlink, ie a site page address, is selected in the second database.

This selection step 120 is carried out, for example, by a calculation unit of the computer server configured to select at least one hyperlink from the stored hyperlinks as a function of the closeness of characters determined and associated to each hyperlink and each character entered by the user.

Each hyperlink selected in this way is displayed, during the second display step 125, in the input area opposite the characters entered. For example, if the entered characters are displayed on the left of the input area, at least one hyperlink is displayed on the right of this input area.

Preferably, each character entered is displayed in a first portion of the input area, each hypertext link being displayed in a second portion of the input area, different from the first portion.

In some variants, the second display step 125 displays a plurality of hyperlinks in succession, the first hyperlink displayed being the most relevant hyperlink identified by utilizing the search algorithm in the second database. In these variants, each hyperlink of the plurality of hyperlinks is displayed according to an order determined as a function of a keyword number determined as a function of each character entered that led to said keyword being selected.

In some variants, this hyperlink is in the form of an image. Preferably, the dimensions of this image allow it to be fully displayed in the input area. In other variants, the input area is enlarged as a function of the dimensions of the image.

When a user clicks on a hyperlink, the browser displays a page corresponding to this hyperlink's address.

In some embodiments, the input area comprises an area for displaying predictive search complements, with at least one selected hyperlink being displayed in the display area, each said hyperlink being selected as a function of a displayed predictive search complement.

These predictive search complements are determined, for example, as a function of a probability measure of the complement being entered based on previous entries made by the user or by a set of users.

This area for displaying complements is displayed, for example, below the input area. In this way:
a primary hyperlink can be displayed opposite the area for entering characters, this primary hyperlink being selected solely as a function of characters entered, and
at least one secondary hyperlink can be displayed opposite search complements in the area for displaying complements, each secondary hyperlink being selected as a function of characters entered and displayed search complements.

In some variants, the area for displaying complements occupies the entire input area, the complements being displayed as the user enters characters.

In some embodiments, each hyperlink is also selected as a function of a user profile. This user profile can be entered by the user or deduced as a function of previous search entries. This user profile comprises, for example, a plurality of fields relating to attributes of the user, the search in the first database being carried out as a function of values of these attributes and characters entered by the user. This makes it possible, in particular, to provide objective results targeted according to the user.

In some embodiments, each hyperlink is also selected as a function of an item of information representative of a cookie of a browser displaying the input area. These embodiments allow the results of the search to be targeted as a function of pages viewed by the user.

In some embodiments, the method 10 comprises, after the detection step 115, a step 140 of determining at least one keyword neighboring at least one keyword formed by each character entered, the selection step being performed as a function of at least one determined neighboring keyword. This determination step 140 is performed, for example, by utilizing an algorithm identifying a keyword as a function of a syntactic closeness with at least one keyword formed by the characters entered. In this way, if a user has made an error typing a keyword, the determined keyword is used to carry out the selection in the second database.

In some embodiments, the second display step 125 displays in priority a hyperlink selected as a function of at least one character detected relative to a hyperlink selected as a function of at least one determined neighboring keyword.

In some embodiments, the selected hyperlink corresponds to a hyperlink obtained by searching an external search engine as a function of characters entered. For example, entering “flight Paris New York” in the input area leads to the search, on a search engine of an online site selling plane tickets, for a commercial offer corresponding to a return flight between Paris and New York, the hyperlink displayed being, for example, “Paris-New York return flight from 599€ on suchandsuch a site”. In these embodiments, the second database cannot be accessed directly from the server responsible for the objective search of results limited to access to the first database. The second database can be accessed from a computer server responsible for the search on the external search engine.

The choice of external search engine is made as a function of characters entered, these characters making it possible to determine a search context.

Therefore, as can be seen, the results displayed in a second portion of the page displayed or in a new page, once the search has been carried out, contain no sponsored hyperlink, these hyperlinks being selected in the first database. In this way, the search results are sorted in an objective way, which makes these results more reliable. This makes possible, at the same time, a time reduction for the user and a reduction in the number of results displayed, which reduces, in particular, the energy consumption linked to carrying out the search.

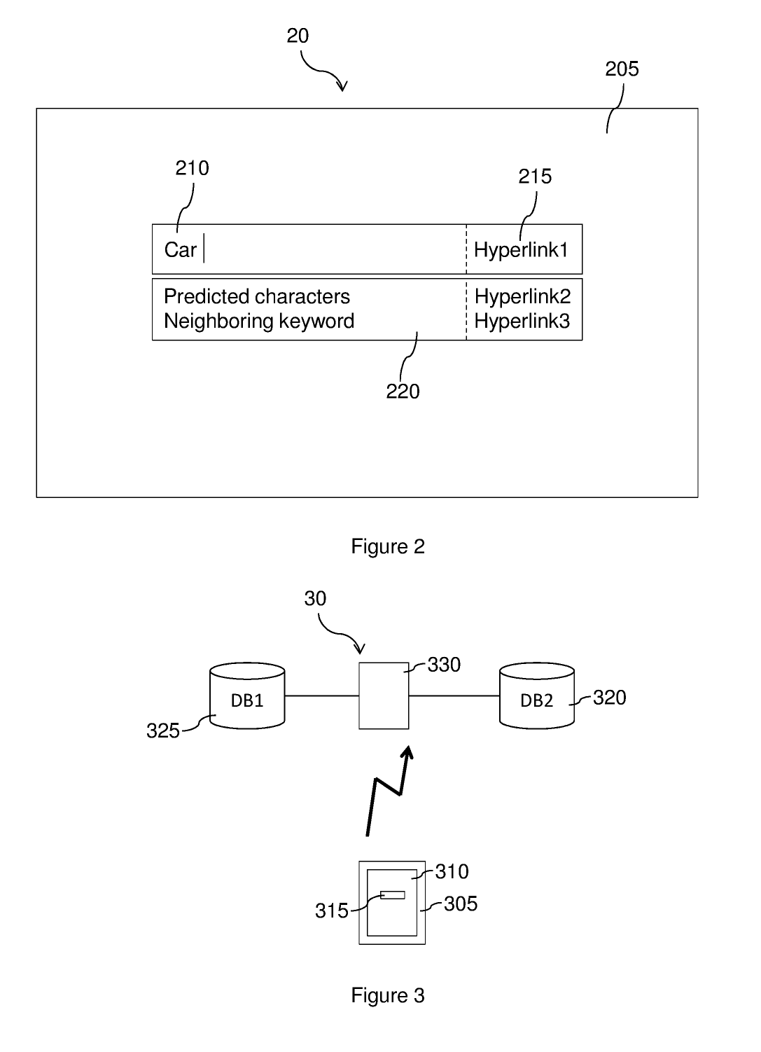

FIG. 2 shows, schematically, a page 205 displayed at the end of a method 10 as described with regard to FIG. 1 on a connected terminal's screen 20. In this page 205, an input area 210 is displayed. In this input area 210, the characters “Car” have been entered by a user in a first portion of the input area, on the left. Opposite these characters, a hyperlink is displayed in a second portion 215 of the input area, to the right.

An area 220 for displaying proposed predictive search complements is positioned under the input area 210. In this display area 220, a search complement is proposed and, opposite this search complement, a hyperlink is displayed. This hyperlink is selected as a function of characters entered and the proposed search complement.

In this display area 220 is also displayed a keyword neighboring a keyword formed by the characters entered by the user, a hyperlink being displayed opposite this determined keyword. The displayed hyperlink is selected as a function of the determined keyword.

FIG. 3 shows, schematically, a particular embodiment of a network architecture 30 enabling the utilization of the method 10 that is the subject of the present invention.

This architecture 30 comprises a connected terminal 305 comprising a screen 310 on which an input area 315 is displayed. Based on the characters entered in the input area 315, a search can be carried out by a server 330 in a first database 325. Based on the same characters, or according to the embodiments described with reference to the method 10 of FIG. 1, the server 330 carries out a hyperlink search in a second database 320.

Each hyperlink selected in this way during the search is displayed on the screen 310 of the connected terminal.

1-10. (canceled)

11. Method for displaying information complementary to a search entry carried out in a first database, comprising:
a first step of displaying, on a screen of a connected terminal, an area for entering characters related to a search to be carried out in the first database;
a step of entering at least one character in the input area of the search to be carried out;
a step of detecting each character entered;
a step of selecting, in a second database, at least one hyperlink as a function of each detected character; and
a second step of displaying each selected hyperlink in the input area.

12. Method according to claim 11, wherein the input area comprises an area for displaying predictive search complements, with at least one selected hyperlink being displayed in the display area, each said hyperlink being selected as a function of a displayed predictive search complement.

13. Method according to claim 11, wherein each character entered is displayed in a first portion of the input area, each hypertext link being displayed in a second portion of the input area, different from the first portion.

14. Method according to claim 11, wherein the hyperlink is in the form of an image.

15. Method according to claim 11, wherein each hyperlink is also selected as a function of a user profile.

16. Method according to claim 11, wherein each hyperlink is also selected as a function of an item of information representative of a cookie of a browser displaying the input area.

17. Method according to claim 11, which comprises, after the detection step, a step of determining at least one keyword neighboring at least one keyword formed by each character entered, the selection step being performed as a function of at least one determined neighboring keyword.

18. Method according to claim 17, wherein the second display step displays in priority a hyperlink selected as a function of at least one character detected relative to a hyperlink selected as a function of at least one determined neighboring keyword.

19. Method according to claim 11, wherein the second display step displays a plurality of hyperlinks in succession.

20. Method according to claim 19, wherein each hyperlink of the plurality of hyperlinks is displayed according to an order determined as a function of a keyword number determined as a function of each character entered that led to said keyword being selected.
